(19) United States
(12) Patent Application Publication
(10) Pub. No.: US 2013/0309344 A1
(43) Pub. Date: Nov. 21, 2013

(54) DOUBLE DIE PELLET MACHINE

(71) Applicant: Klaus Werner Posselt, Burns Lake (CA)

(72) Inventors: Klaus Werner Posselt, Burns Lake (CA); James David Woodford, Nackawic (CA)

(73) Assignee: Klaus Werner Posselt, Burns Lake, BC (CA)

(21) Appl. No.: 13/704,422

(22) PCT Filed: Jun. 14, 2010
(86) PCT No.: PCT/CA2010/000879

§ 371 Date: Jul. 28, 2013

(51) Int. Cl. B30B 3/00

(52) U.S. Cl. CPC B30B 3/00
USPC 425/237; 425/233

(57) ABSTRACT

A pellet machine includes a hopper feeding a pair of inter-locking counter-rotating dies. Feeders convey material from the hopper to pre-compression rollers on the dies. A mat of the material is rotated on the dies into a nip between the pair of dies. Teeth on each die are in opposed facing relation to the teeth on the opposite die as the teeth rotate into the convergence area in the nip. Pellet forming chambers are inter-leaved between the teeth on both dies. The teeth are offset between the two dies so that the teeth act as plungers driving and compressing the material mat into and through the chambers as the teeth on each die drive into the opposed facing depression between the teeth on the opposite die. The material is driven through the chambers to extrude into the interiors of the dies.

### FIELD OF THE INVENTION

The present invention relates to the field of pellet machines and in particular to a double die pellet machine having two meshing counter-rotating dies wherein inter-locking teeth, having pelletizing chambers therebetween alternatingly compress pelletizing material into oppositely disposed chambers as the dies counter-rotate thereby drawing the material from the nip down between the dies.

### BACKGROUND OF THE INVENTION

Generally, a pellet mill is a type of mill used to create cylindrical pellets from a mixture of dry powdered feedstock, such as flour, sawdust, or grass and a wet ingredient, such as molasses or steam. The pellets are made by compacting the mash or meal through many small holes in a die. The die is usually round and the pellets are pushed from the inside out. Pellet mills are used in the production of animal feeds, and of wood and grass fuel pellets for use in a pellet stove. Torrefied material has in the past proven to be difficult to pelletize.

In the prior art applicant is aware of U.S. Pat. No. 2,887,718 which issued May 26, 1959, to Curran et al for a Pellet Mill, wherein a prior art pellet mill is described. Carran et al describe pellet mills in which the rolls are stationarily supported within an annular die, and the die is mounted for rotation with respect to the rolls. In operation a mass of pulverous material to be pelleted is introduced into the interior of the die. As the die rotates, the material is carried through the nips formed by the inner surface of the rotating die and the stationarily supported rotatable rolls bearing thereagainst, thus forcing the material outwardly through perforations or extrusion openings in the die. Cut-off knives are mounted adjacent the outer surface of the die to cut off the extruded pellets as the material emerges outwardly from the perforation.

In the prior art applicant is also aware of U.S. Pat. No. 3,932,091 which issued Jan. 13, 1976, to Vink for a Pellet Mill with Separate Feed Means for Each Die Roller, wherein a further prior art pellet mill is described. Vink describes that pellet mills usually comprise a rotary annular die having a great number of radial die openings and enclosing an interior die space which is closed on one side and open on the opposite feed side. At its closed side the die is supported on one end of a horizontally mounted hollow drive shaft. A number of extrusion rollers, for instance two such rollers are rotatably mounted in a common roller frame arranged in the interior of the die, the extrusion rollers cooperating with the inner cylindrical surface of the annular die in pressing flour product fed to the die radially outwardly through the die openings. The roller frame is secured on one end of a second shaft extending through and rotatably mounted in the hollow drive shaft. Shear pin means or the like connect the opposite end of this second shaft to the frame of the mill for holding the second shaft and thus the roller frame stationary during normal operation of the mill. Feed means are arranged opposite the open side of the rotary annular die for feeding the flour product to be pressed to the interior of the die.

During the operation of a pellet mill of the above-described type the feed means is taught to preferably feed the flour product to the die forwardly of the extrusion allowing these rollers to press the material through the die openings whereby bar-shaped pellets are extruded which are cut to length by cutters engaging the cylindrical outer surface of the die. For a proper and efficient operation of the pellet mill it is taught to be of importance that the material to be pressed is not only fed in equal portions to the several extrusion rollers but is also distributed evenly over the axial length of each roller and thus also over the effective width of the annular die in order to make full use of the capacity of the pellet mill and to avoid uneven wear of the rollers and of the die. However, for obtaining such an even distribution it is generally not allowable to use feed means which extend from outside the die into the die interior. The reason for this is that the extrusion rollers and the die must be protected against possible damage caused by overloading or by the occurence of foreign hard matter such as a piece of iron or stone, in the supplied flour product. If such a foreign hard body is clamped between a roller and the die and consequently the driven die exerts a rotational force on the roller frame, the shear pins normally holding the shaft of the roller frame stationary will break whereby the roller frame can rotate together with the die before the hard body can cause rupture of the die or other damage. Rotation of the central shaft supporting the roller frame causes the drive motor of the mill to be switched off. Vink describes a feed assembly for feeding the flour product to the interior of the annular die where the feed assembly has a plurality of separate feed means, one associated with each of the several extrusion rollers.

### SUMMARY OF THE INVENTION

In summary, the pellet machine according to the present invention may be characterized in one aspect as including a hopper feeding a pair of counter-rotating dies. The hopper holds pelletizing material. At least one feeder, having an upstream end and opposite downstream end, conveys at its upstream end material from the hopper and deposits the material from the downstream end into a nip between pair of dies. The counter-rotating dies are arranged as a substantially vertically standing inter-locking pair. The dies counter-rotate about a corresponding substantially parallel, substantially horizontal pair of axes of rotation. The dies form a nip therebetween at an upper convergence of a convergence area of the interlocking pair of dies. The pair of dies interlock in the convergence area. The dies counter-rotate so as to draw the pelletizing material down from the nip into and through the convergence area,

The pair of dies may be characterized as first and second dies having first and second teeth, respectively. The first and second teeth are arranged around an outer circumference of the first and second dies respectively. The first and second teeth are offset so as to interlock within the convergence area in meshing engagement therebetween,

The first and second dies have first and second depressions formed between the first and second teeth respectively. First and second pellet forming chambers cooperate with corresponding first and second depressions. The chambers extend from the outer circumference to a radially inner surface of the first and second dies respectively.

The first and second teeth are sized to nest into the second and first depressions respectively to thereby compress the pelletizing material drawn down from the nip into the second and first depressions respectively as the pair of dies counter-rotate, and thereby extrude the material as extrusion from the chambers and through corresponding apertures formed in the radially inner surfaces of the first and second dies.

A pellet cutter, for example a knife is mounted within each of the first and second dies. The knives cooperate with the radially inner surfaces to cut pellets from the extrusions.

Advantageously at least one pre-compression roller is mounted, adjacent so as to be positioned above the nip, in rolling engagement on the outer circumference of the first and second dies.

The at least one feeder may be a pair of feeders, each feeder of the pair of feeders feeding a corresponding one die of the pair of dies. The at least one pre-compression roll may be at least two the pre-compression rollers, for example so as to form an array of rollers.

The teeth may be matrices of radially spaced apart and laterally spaced apart teeth distributed across and circumferentially completely around the outer circumference of the pair of dies.

The hopper may include a frusto-conical pot diverging towards a base thereof.

The pair of dies may be driven by a corresponding pair of inter-meshing gears. The gears may be shaft driven or maybe driven by a third gear, itself shaft driven and/or belt driven by a motor. The third gear may be mounted over the nip between the pair of gears, or may be offset to one side so as to engage one gear in the pair of gears. The third gear may be a spur gear.

### BRIEF DESCRIPTION OF THE DRAWINGS

In the drawings wherein like numerals of reference depict corresponding parts in each view,

FIG. 1 is, in perspective view, one embodiment of the double die pellet machine according to the present invention.

FIG. 2 is a plan view of the pellet machine of FIG. 1.

FIG. 3 is a right side elevation view of the pellet machine of FIG. 1.

FIG. 4 is a front elevation view of the pellet machine of FIG. 1.

FIG. 5 is a partially cut-away view of FIG. 4 to show the re-compression rolls.

FIG. 5a is a section view along line 5a-5a in FIG. 5.

FIG. 6 is a section view through the front elevation of FIG. 4 illustrating the pre-compression rollers engaging against the upper outer surfaces of the pair of counter rotating dies.

FIG. 7 is, in perspective view, the pair of counter rotating dies of the double die pellet machine of FIG. 1.

FIG. 8 is an enlarged view of a portion of FIG. 7 showing, in front elevation, the intermeshing of the teeth in the convergence area of the double dies beneath the nip.

FIG. 9 is an enlarged portion of FIG. 8 showing in greater detail, the interlocking meshing of the opposed facing teeth in the convergence area of the double dies.

FIG. 10 is, in perspective view, the pellet machine of FIG. 1 with the distribution pot, screw feeders, pre-compression rolls, covers, motors and drive assemblies (with the exception of the arbors) removed.

FIG. 10a is the view of FIG. 10 with a driven spur gear mounted between the timing gears.

FIG. 11 is, in front elevation view, the pellet machine of FIG. 10.

FIG. 12 is a section view along line 12-12 in FIG. 11.

FIG. 13 is an enlarged partially cut-away view of FIG. 12.

FIG. 14 is, in plan view, the pellet machine of FIG. 10.

FIG. 15 is in enlarged perspective view, an alternative embodiment of the pelletizer according to the present invention.

FIG. 16 is, in perspective view, the overall pelletizer of FIG. 15.

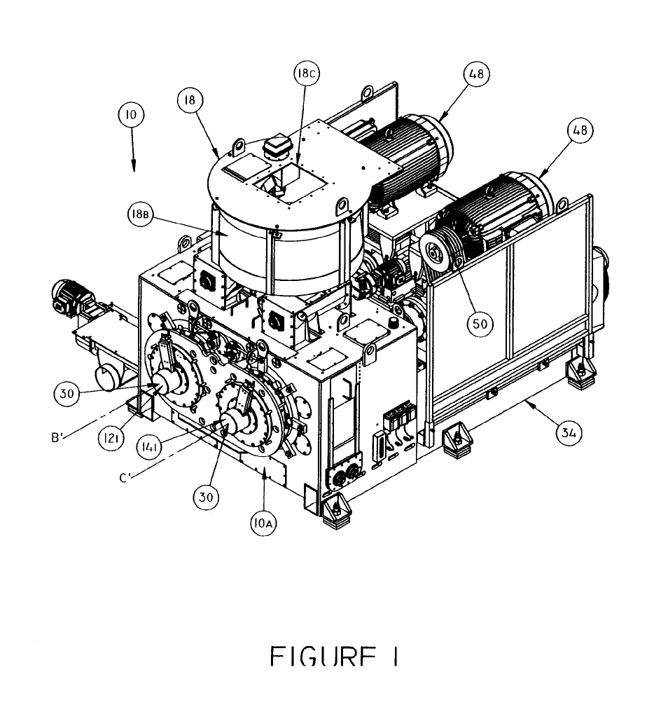

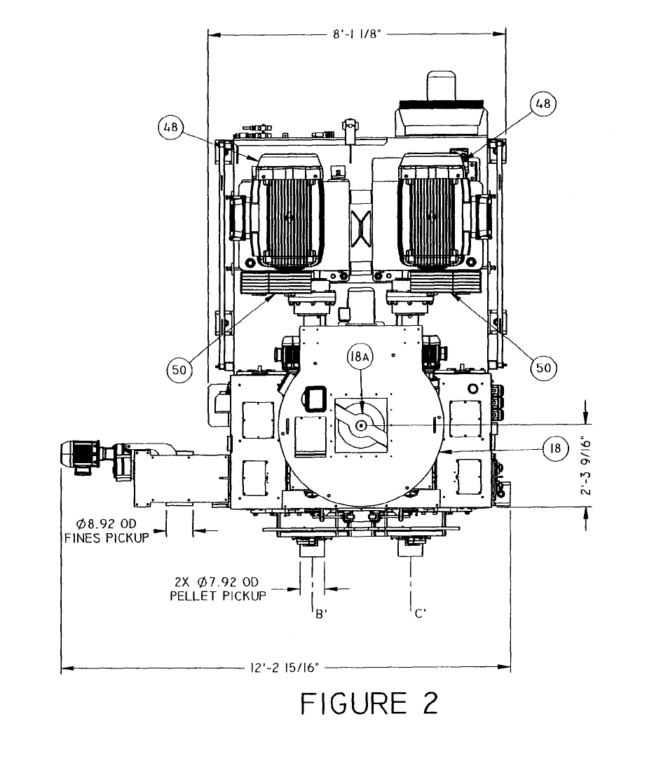

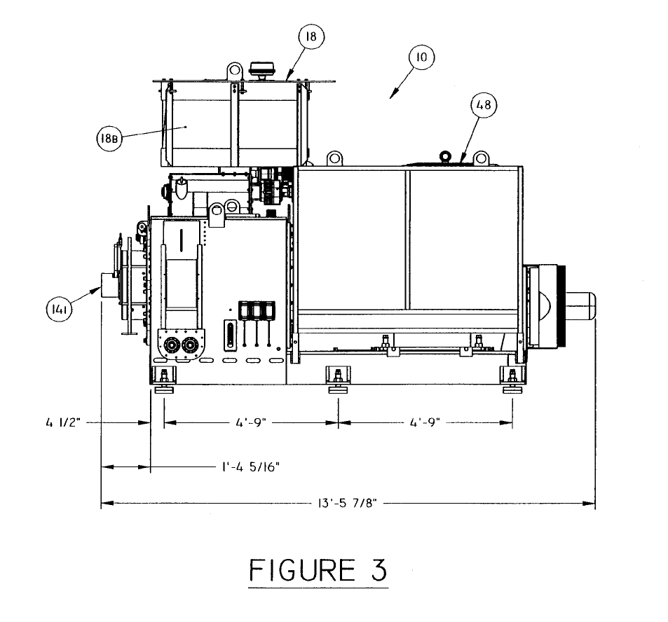

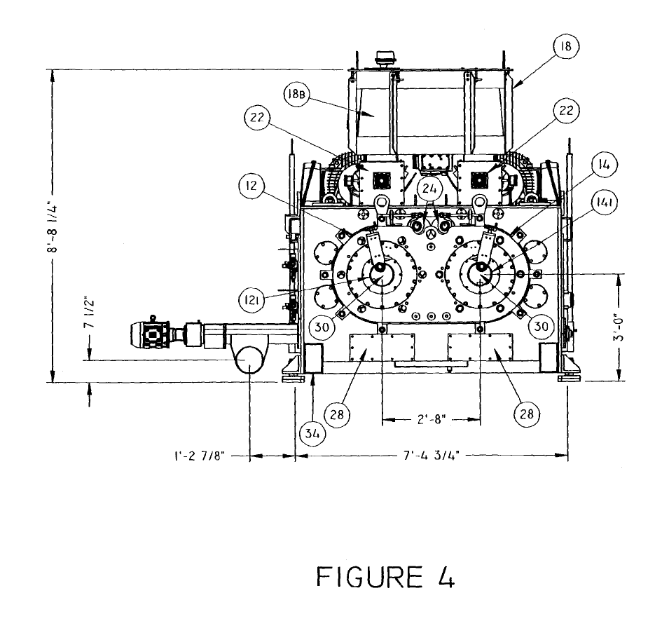

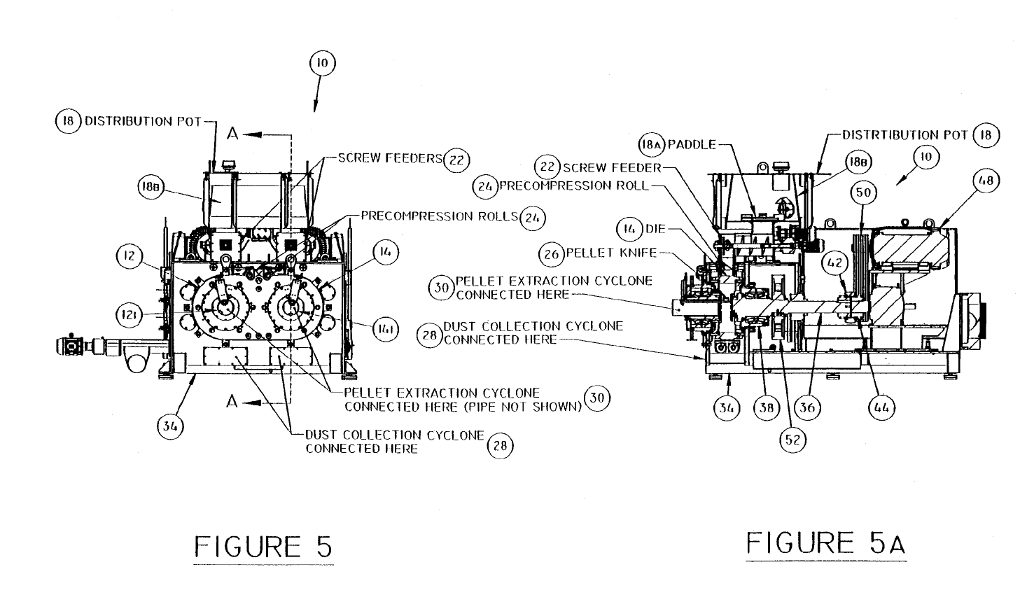

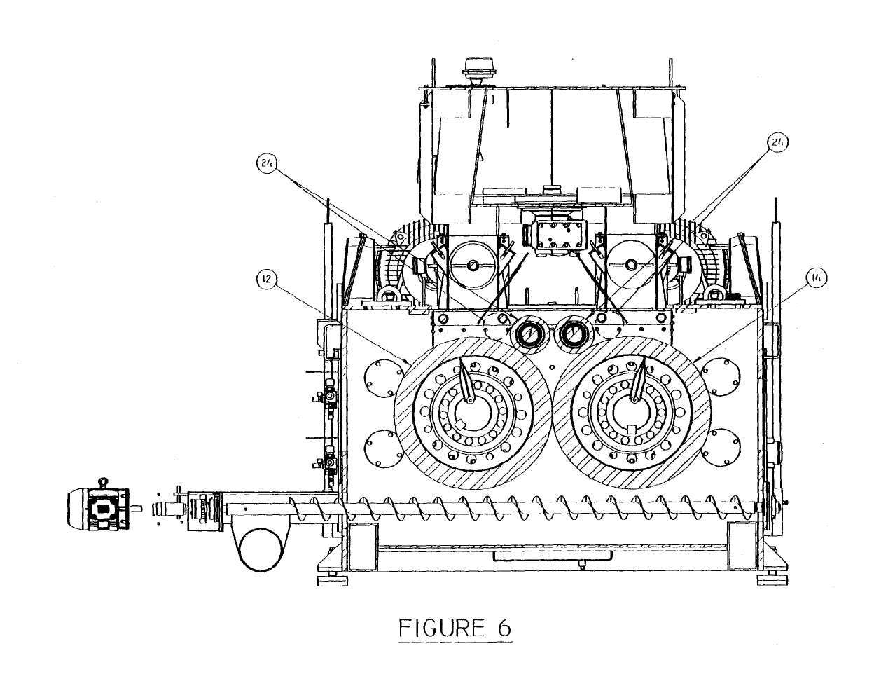

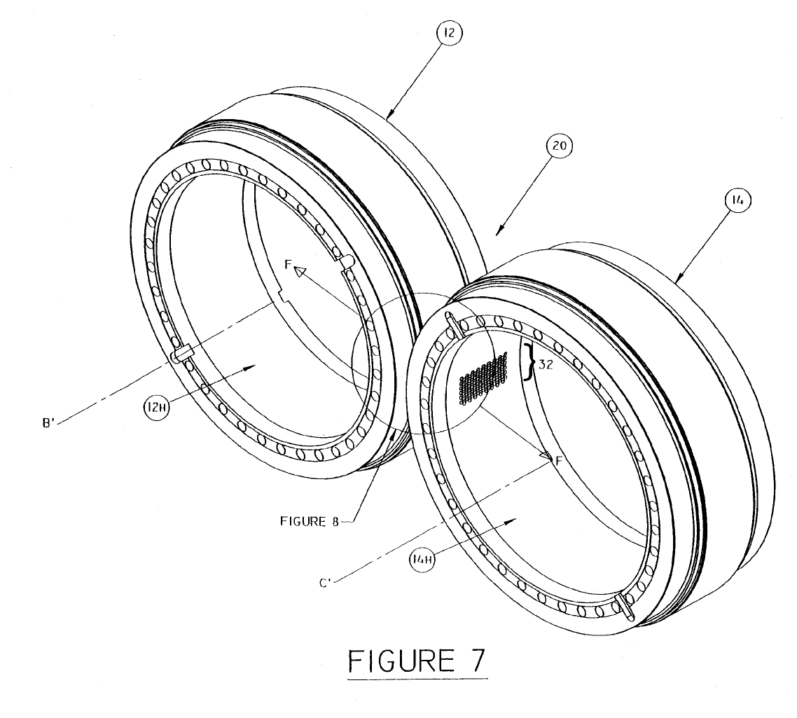

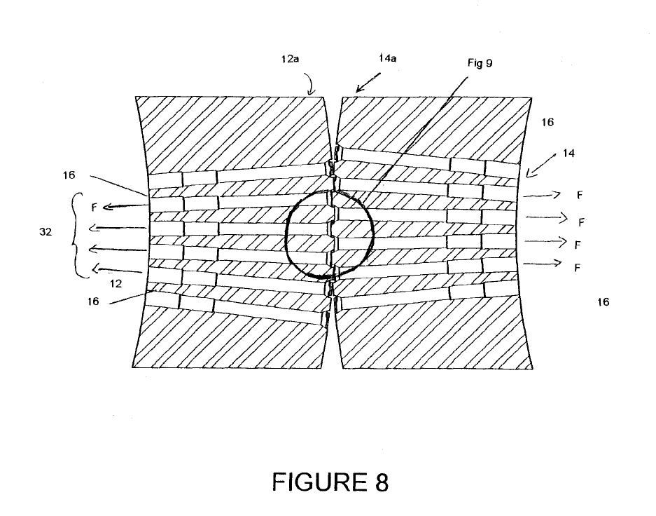

### DETAILED DESCRIPTION OF EMBODIMENTS OF THE INVENTION

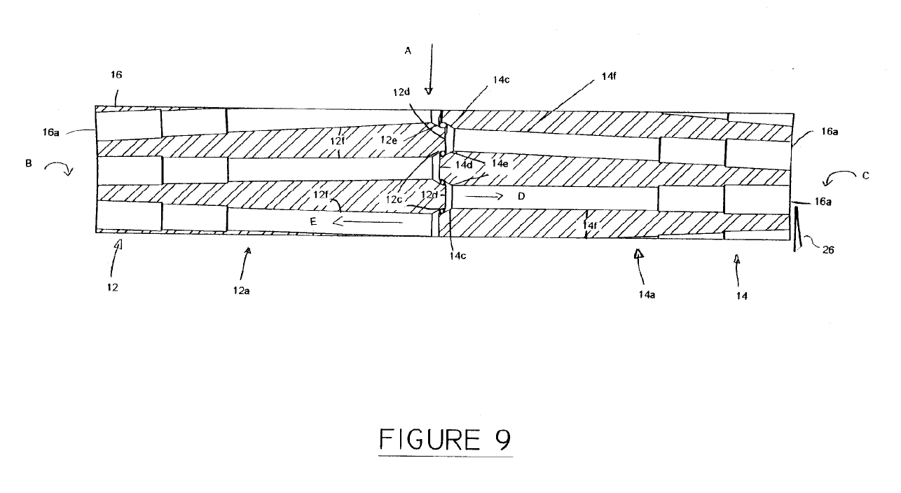

The double die pelleting apparatus 10 according to the present invention uses two counter rotating dies 12 and 14 positioned such that the outer diameters 12a, 14a of the dies 12,14 overlap and mesh into one another in a fashion similar to two meshing gears in a gear train. Material 16 to be pelletized 16 is stored in distribution pot 18 and is introduced into the nip 20 or “V” formed by the counter rotating dies. Material 16 is extruded by the compressive forces generated by the overlapping faces extruding the material through the chamber holes to the inside of the corresponding die. For example, material 16 for pelletizing having been fed into nip 20 is entrained in direction A as seen in FIG. 9 so as to be compressed between the meshing teeth of dies 12 and 14 as they counter rotate in directions B and C respectively on their parallel axes of rotation B′ and C′ respectively. Material 16 entrained between oppositely disposed teeth on the outer diameters 12a and 14a is compressed by the flush mating of: faces 12e with opposite faces 14c, and faces 12c with opposite faces 14e thereby causing opposite faces 12d and 14d to act as pistons driving material 16 in directions D and E through corresponding hollow chambers 12f and 14f.

This geometry provides benefits over conventional single die and roll shell machines. The intermeshing geometry and the pair of timing gears 52 prevent slippage between the material 16 and the two dies 12, 14. In conventional machines such slippage can create excessive friction and heat and lead to fires inside the die chamber. The geometry exerts shearing forces on the material 16 to be pelletized which in turn conditions the material 16 by softening and reducing it. This makes materials that are typically difficult to pelletize in a conventional pellet machine easier to pelletize. It exerts compressive forces on the material 16 prior to entering the chambers 12f, 14f which improves the flow of the material through the die chamber and reduces the power required to operate the pelleting machine.

The teeth are machined on the outer diameter of the dies so that betweem the two dies the opposed facing teeth are offset so as to mesh. The teeth promote the retention of material 16 to the die face as opposed to the material falling off and having to be recycled back to the distribution pot 18 and re-introduced into the pellet making process. The dies spread the compressive forces over a larger pelletizing area than a conventional die and roll shell machine which reduces die wear and breakage.

The machine also includes two screw feeders 22, two pre-compression rolls 24, and two pellet knives 26. Advantageously a dust collection cyclone and a pellet extraction cyclone are provided.

Distribution pot 18 is mounted on top of the machine. Conventional double die pellet machines use a distribution pot having vertical wall and sight glass to monitor material level in the pot. The vertical wall and the rivets used to fasten the sight glass to the pot wall promote material bridging which can interrupt the flow of material to the dies and cause the dies to plug. The distribution pot 18 according to the present invention incorporates a frusto-conical wall 18b having a five degree negative taper. Level sensors may be used to detect high and low material conditions. The negative wall slope and lack of sight glass help ensure material bridging does not occur in distribution pot 18. The inlet 18c at the top of the pot may be equipped with a magnet to remove unwanted tramp metal from the material flow that could potentially seriously damage or destroy the dies. Material 16 to be pelletized is introduced into the top of distribution pot 18. A rotating paddle 18a inside at the bottom of the distribution pot distributes material 16 to each of the two screw feeders 22 which deliver material 16 from the feeders' upstream ends to their downstream ends so as to deliver the material to the top of each counter rotating die 12, 14. Material 16 falls from the end of each of the two screw feeders 22 and lands on the outer diameter 12a, 14a of the dies. The pre-compression rolls 24 flatten the infeed pile of material 16 deposited by feeders 22 to evenly distribute the material 16 across the faces of the dies, to promote flow through the outer chambers on the rims, that is, 12g, 14g near the edges of the dies 12, 14, and to compress material 16 to remove any fluffiness created by air pockets in the material. The flattened infeed pile then rotate into the nip 20.

The material 16 then is drawn down from the nip 20 and compressed between the dies 12, 14. Material 16 is then extruded through the chambers 12f, 14f toward the inside of the dies, that is, towards and through inner annular walls 12h, 14h in a radially inward direction (direction F). Pellet knives 26 are mounted radial to the inner annular walls 12h, 14h of each die 12, 14 where the pellets of material 16 emerge in direction F from the chambers 12f, 14f. The pellet knives shear or break the pellets off at a length controlled by the position of the knife in relation to the inner diameter of the die. The knives direct the pellets into a pipe (not shown) that is connected to the pellet extraction cyclone. The pellet extraction cyclone pulls the pellets from the hollow cores 12i, 14i inside the dies, and transports the pellets via ports 30 to a holding bin (not shown) ready for bagging or bulk shipping.

Any material 16 that is not forced through the chambers 12f, 14f in the convergence area of meshing overlap 32 may fall of the die face as it continues to rotate and fall to the bottom of the pellet machine frame 34. The dust collection cyclone extracts this excess material from ports 28 and returns it to the distribution pot 18 to be re-introduced into the process.

The pellet knife design on conventional double die pellet machines requires the machine to be shut down in order to adjust the knife's position, which in turn adjusts the pellet length. The knives on the double die pellet machine according to the present invention are mounted on dovetail slides. The dovetail slides make the knives very rigid, allow for very fine knife adjustment, and allow for adjustment while the machine is in operation.

The frame design used on conventional double die pellet machines does not allow the dies to be installed in or removed from the machine as a meshed pair. This means the dies must be individually installed on their respective arbor and then timed or indexed properly while in the machine to ensure the dies do not collide. Due to the limited space inside the frame and the weight of the dies and associated parts, this becomes a difficult and time consuming task. The frame according to the present invention allows the front 10a of the machine to be removed such that both dies can be installed in or removed from the machine as a pre-meshed pair. A timing jig may be used to properly index the dies on a bench where access is not restricted. The timing jig may be double as a die lift plate to attach to a crane when installing or removing the dies.

The pair of main arbors 36 and their bearings 38 uses a pair of tapered roller bearings 38d mounted back to back. The inner and outer spacers 40 between the two tapered roller bearings 38a are machined to provide the proper bearing preload.

The main arbor drive gearboxes on conventional double die pellet machines are flange mounted to the machine frame. The main arbor has a female spline and the gearbox has a male spline that slides into the arbor. This places the reciprocating forces due to misalignment and wear on the arbor and gearbox output shaft, both of which are time consuming and costly to replace. The pellet machine of the present invention uses a gear coupling 42 with one half shrunk fit onto the gearbox output shaft 44 and the other half shrunk fit onto the arbor 36. This places the reciprocating forces due to misalignment and wear on the coupling 42 that is readily available and easily replaced by flame cutting it free along its keyway. Gearboxes 46 are driven by motors 48, via drive belts 50. Dies 12, 14 and timing gears 52 are mounted onto arbors 36.

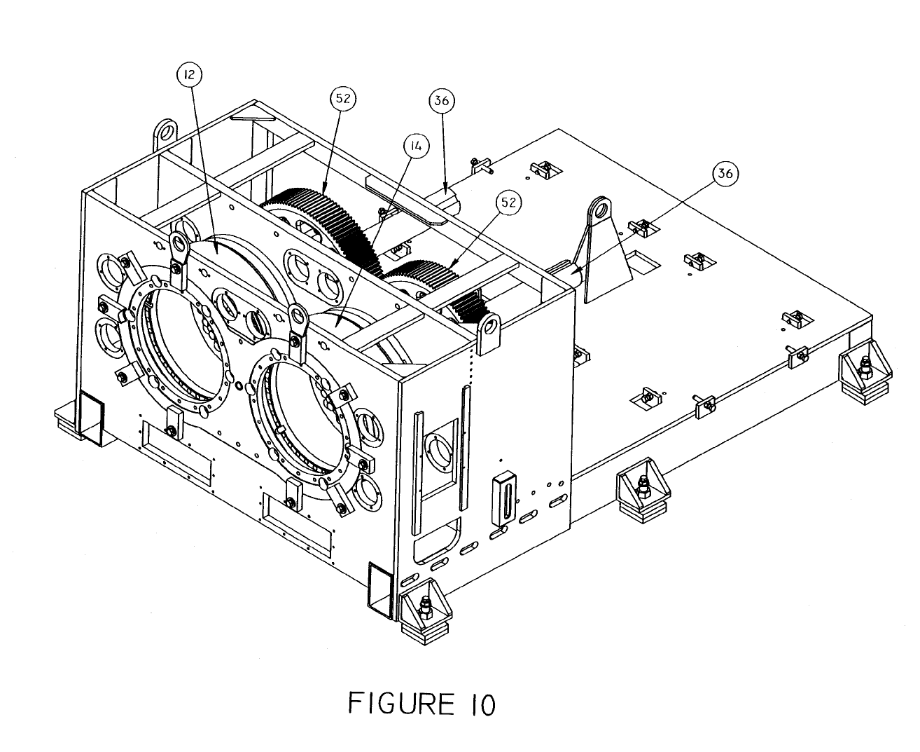

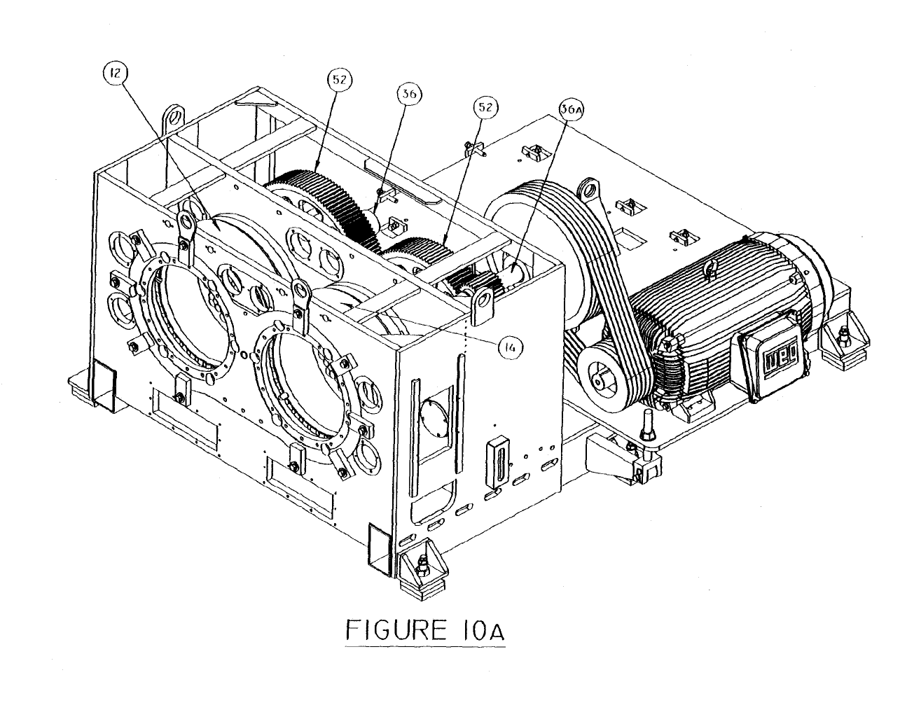

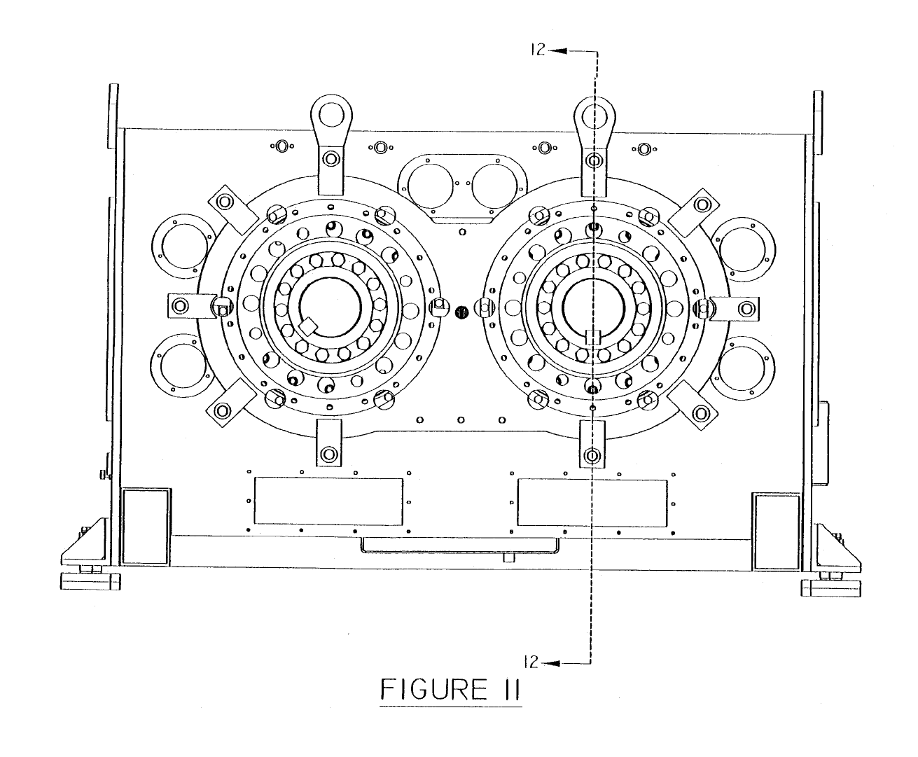

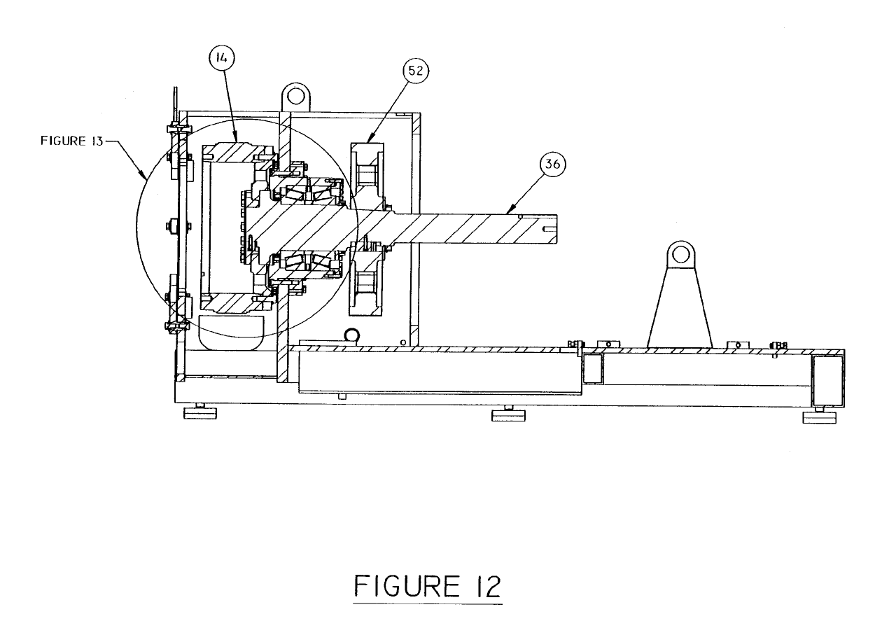

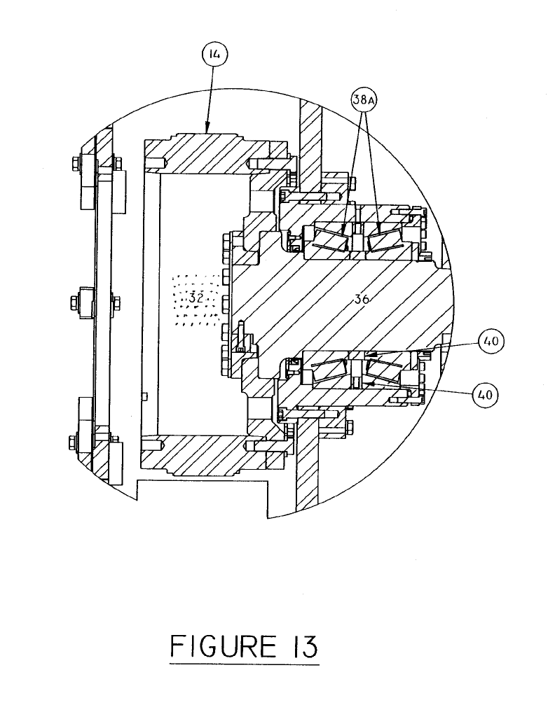

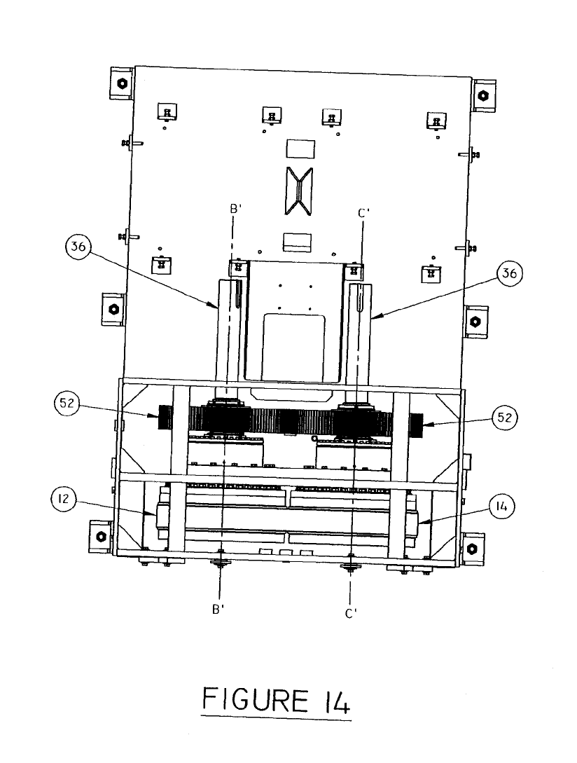

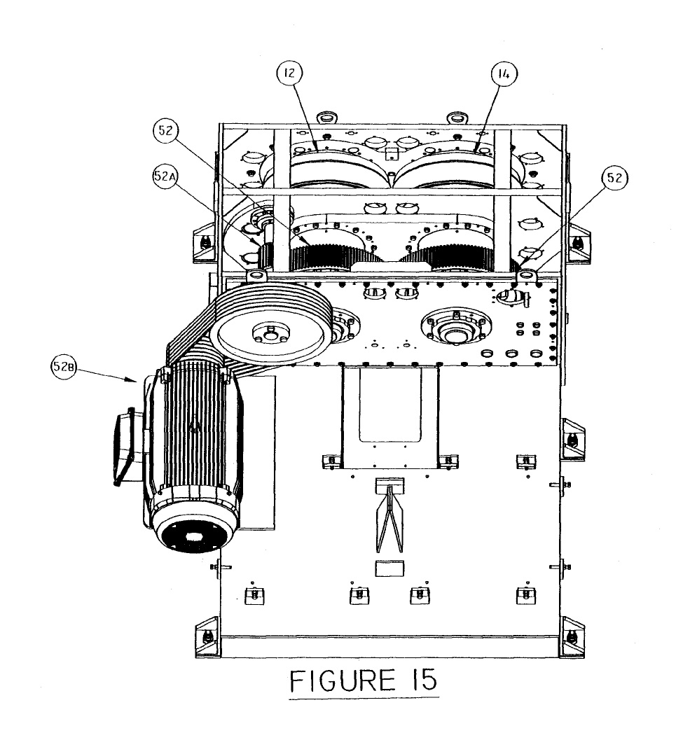

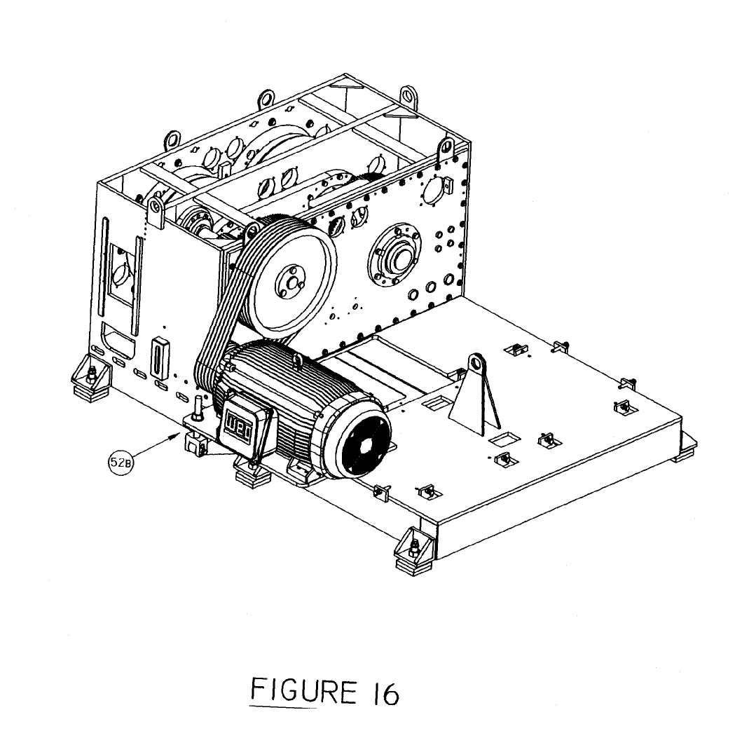

In the alternative embodiment of FIG. 10a, a driven spur gear 52a mounted on shaft 36a (shaft 36a shown partially cut-away in FIG. 10a) engages the teeth of timing gears 52. As one example of the gear reduction, which is not intended to be limiting, if timing gears 52a may have 22 similarly sized teeth providing a 5.45 gearing ratio. Spur gear 52a may be run in the order of 100-300 rpm, and in one preferred embodiment in the range of 150-200 rpm driven by an approximately 400 horsepower motor. As seen in FIGS. 10a, 15 and 16, spur gear 52a may be variously positioned so as to engage one of the timing gears. Spur gear 52a maybe shaft mounted. The shaft may be directly driven or belt driven by a dedicated motor 52b.

As stated above, the two rotating dies 12, 14 interlock. In particular, the teeth around the dies are offset. Each pellet chamber (12f, 14f) on one die (12, 14) lines up with a plunger face (12d, 14d) from the opposite die. This reduces unproductive compression areas between the holes in a die. The double dies 12, 14 use all areas under pressure to manufacture pellets 16a. This results in a reduced power consumption of approximately 80 kWh per ton of pellets as compared to conventional pelletizing machines which may use 100-120 kWh per ton.

The chamber holes and the plunger faces are configured so that the wood residue material is compressed in funnel like pre-compression chambers form in the recesses between adjacent teeth. In these chambers the material 16 reaches temperatures of up to 150 degrees Celsius (300 degrees Fahrenheit) prior to entering the pellet chambers 12f, 14f. This compression results in heat and evaporation of moisture in the material. Initial moisture levels are gradually reduced from approximately 15 percent to 10 percent or less as the dies rotate. In this process the pellet material is squeezed and the lignum is softened and moisture is released. The die makes one or more revolution and moisture continues to evaporate from the pre-compressed material. A new layer of material is applied and pre-compression rollers 24 remove some of the air.

As the material is moving through the pellet chambers (12f, 14f), moisture continues to separate from the actual wood fiber and evaporates as it reaches the relief area in the pellet chambers. The pellets 16a are still attached. Once they reach their preset length they are cut off while moisture continues to evaporate. At this point the pellets have reached a temperature of approximately 50 degree Celsius (120 degrees Fahrenheit). Once the pellets are produced they are picked up by the cyclone vacuum system and moved to the screening process. The tumbling and screening process removes all the fines and sharp edges from the pellets. The screened fine are re-introduced into the pelletizing process for reuse. All these steps result in a pellet moisture content of approximately 7-8 percent as compression of material proceeds as the dies rotate and specific pellet density up to 90 lbs/ft3. Preliminary results indicate that torrefied feed material may be accommodated and pelletized.

FIG. 9 shows the pre-compression zone in the pelletizer double die system of the present invention where the softening of the lignum and evaporation of excess moisture occurs. This process conditions the material for optimum pelletizing. Prior to entering the double die system the material is dried to 18 percent. An additional 3 percent may be lost in a hammer mill process immediately prior to the pelletizer. Rollers 24 are driven and pre-compress the layer of loose material 16 gradually increasing the density removing air to form the material carpet in fed into nip 20.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A pellet machine comprising:
a hopper for holding pelletizing material, at least one feeder having an upstream end and opposite downstream end, for conveying at said upstream end the material from the hopper and depositing the material from said downstream end,
counter-rotating dies arranged as a substantially vertically standing inter-locking pair and counter-rotating about a corresponding substantially parallel, substantially horizontal pair of axes of rotation, said first and second dies forming a nip therebetween at an upper convergence of a convergance area of said interlocking pair of said dies wherein said pair of dies interlock,
said feeder adapted to deposit the material from said downstream end into said nip, said dies counter-rotating so as to draw the material down from said nip into and through said convergence area,
said first and second dies having first and second teeth, respectively, said first and second teeth arranged around an outer circumference of said first and second dies respectively, said first and second teeth offset so as to interlock within said convergence area in meshing engagement therebetween,
said first and second dies having first and second depressions formed between said first and second teeth respectively, and first and second pellet forming chambers cooperating with corresponding said first and second depressions, said chambers extending from said outer circumference to a radially inner surface of said first and second dies respectively,
wherein said first and second teeth are sized to nest into said second and first depression respectively to thereby compress the material drawn down from said nip into said second and first depressions respectively as said pair of dies said counter-rotate, and thereby extrude the material as extrusion from said chambers and through corresponding apertures formed in said radially inner surfaces of said first and second dies,
a pellet cutter mounted within each of said first and second dies and cooperating with said radially inner surfaces to cut pellets from said extrusion.

2. The machine of claim 1 further comprising at least one pre-compression roller mounted above said nip and in rolling engagement on said outer circumference of said first and second dies.

3. The machine of claim 1 wherein said at least one feeder is a pair of feeders, each feeder of said pair of feeders feeding a corresponding one die of said pair of dies.

4. The machine of claim 3 wherein said at least one pre-compression roll is at least two said pre-compression rollers.

5. The machine of claim 4 wherein said at least two pre-compression rollers is an array of rollers.

6. The machine of claim 1 wherein said teeth are matrices of radially spaced apart and laterally spaced apart teeth distributed across and circumferentially completely around said outer circumference of said pair of dies.

7. The machine of claim 4 wherein said teeth are matrices of radially spaced apart and laterally spaced apart teeth distributed across and circumferentially completely around said outer circumference of said pair of dies.

8. The machine of claim 1 wherein said hopper includes a frusto-conical pot diverging towards a base thereof.

9. The machine of claim 1 further comprising a pair of substantially parallel arbors on said axes of rotation, said counter-rotating dies mounted on said arbors, a pair of timing gears also mounted on said arbors, said pair of timing gears synchronizing said interlock of said first and second teeth.

10. The machine of claim 9 further comprising motors cooperating with said pair of substantially parallel arbors so as to be drive said counter-rotating dies.

11. The machine of claim 10 further comprising at least one pre-compression roller mounted above said nip and in rolling engagement on said outer circumference of said first and second dies.

12. The machine of claim 10 wherein said at least one feeder is a pair of feeders, each feeder of said pair of feeders feeding a corresponding one die of said pair of dies.

13. The machine of claim 12 wherein said at least one pre-compression roll is at least two said pre-compression rollers.

14. The machine of claim 13 wherein said at least two pre-compression rollers is an array of rollers.

15. The machine of claim 10 wherein said teeth are matrices of radially spaced apart and laterally spaced apart teeth distributed across and circumferentially completely around said outer circumference of said pair of dies.

16. The machine of claim 13 wherein said teeth are matrices of radially spaced apart and laterally spaced apart teeth distributed across and circumferentially completely around said outer circumference of said pair of dies.

17. The machine of claim 10 wherein said hopper includes a frusto-conical pot diverging towards a base thereof.
